(19) United States
(12) Patent Application Publication
(10) Pub. No.: US 2010/0064509 A1
(43) Pub. Date: Mar. 18, 2010

(54) SYSTEM AND APPARATUS FOR DYNAMIC MEASUREMENT OF MEMBERS FOR AN ASSEMBLY

(76) Inventors: David L. McAdoo, Alvarado, TX (US); Timothy K. McAdoo, Grand Prairie, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/546,353

(22) Filed: Aug. 24, 2009

Related U.S. Application Data
(60) Provisional application No. 61/096,518, filed on Sep. 12, 2008.

(51) Int. Cl. B23P 21/00; G01B 5/14

(52) U.S. Cl. 29/705; 33/784

(57) ABSTRACT

An apparatus for providing dynamic measurement of an elongated work piece includes at least one motion controller configured to engage at least one face of the work piece and move the work piece inline relative to the apparatus, a fence and a measurement device. The fence is configured to engage a face of the work piece and define a first reference plane along which inline motion of the work piece progresses relative to the apparatus. The measurement device is configured to engage an opposite face to the face of the work piece engaged by the fence to define a second reference plane, the measurement device being further configured to provide a digital measurement of a distance between the first reference plane and the second reference plane to an electronic device.

### CROSS REFERENCE TO RELATED APPLICATION

This application claims the benefit of U.S. Provisional Application No. 61/096,518, filed Sep. 12, 2008, the contents of which are incorporated herein in their entirety.

### FIELD OF THE INVENTION

Embodiments of the present invention generally relate to truss fabrication and, more particularly, relate to a system and apparatus for improving truss fabrication automation.

### BACKGROUND OF THE INVENTION

Trusses are common components for many construction framing projects. However, despite the ubiquitous nature of trusses, it is relatively rare that any single truss design is replicated to a large extent. As such, many trusses are custom built for a particular construction project. Due to the highly customized residential and commercial construction markets, a strain is placed on truss manufacturers, which may be particularly acute in the area of set up. For that reason, much of the automation associated with truss fabrication has been focused on automating set up functions for cutting and assembly.

Currently, pieces of lumber drawn from stock of standard sizes are cut to a precise length and with a properly angled end, sorted and stacked after sawing, and transported to a staging area where truss assembly is performed. When the production schedule requires, the cut and sorted pieces may be moved to the assembly area along with needed connectors, which may include plates with teeth that imbed at least partially into wood members of the truss at their ends or along their length to hold the members together during the assembly process. The pieces may then be laid into an assembly jig, which provides a form or guide for member placement and truss assembly. The connectors may be placed on both top and bottom faces of the lumber at the joints between adjacent pieces.

Due to the custom nature of truss fabrication, it is often necessary to readjust the jig for each different truss. Accordingly, mechanisms have been developed to increase efficiencies related to setting up a jig. For example, jigging tables using lasers to outline jig or lumber patterns or having slidable guide members for more rapid adjustment of the jig have improved the ability of fabricators to customize jigs. However, the placement of lumber in the jig is typically done manually. The installation of connectors is also typically done by hand.

A problem may result in the assembly of the truss when the standard sized pieces of lumber are not of an expected width. For example, a standard 2×4 is expected to be 1.5″ thick and 3.5″ wide and a standard 2×6 is expected to be 1.5″ thick and 5.5″ wide. As such, the precision lengths and angles measured and cut for each board assume that, for example, a truss web will need to be angled to meet with a truss chord that is 5.5″ in width. Accordingly, if the truss chord is actually 5.25″ or 5.75″ wide the truss web will be cut either a quarter of an inch too short or too long, respectively. The variance in width of the lumber is often due to a corresponding variation in the moisture content of the lumber. As such, the wood shrinks and swells based on often uncontrollable and unpredictable factors.

Wood trusses are manufactured to exacting standards and specifications in order to derive strength, at least in part, from the tight joints that are formed between the truss members. Additionally, the locations of the joints in a truss are an important consideration in the design process. When trusses are assembled manually, brute force and other tricks can be used to fit joints when certain truss members do not quite fit together as planned. However, given that truss manufacturing is likely to remain a highly customized process and also given that mechanisms for automating truss manufacturing may have the capability of providing time and cost savings that may present market advantages to those employing automation techniques, it may be desirable to introduce a system and/or various system components that may assist in overcoming at least some of the disadvantages described above and/or enable further automation of the truss assembly process.

### BRIEF SUMMARY OF THE INVENTION

Accordingly, embodiments of the present invention may provide for a system and device capable of dynamically measuring the width of a truss member during the handling process prior to truss assembly. More specifically, in some embodiments, truss members may be measured for width while the members are being handled for cutting. In this regard, for example, truss members may be held under the control of a board feeding mechanism during cutting. Embodiments of the present invention may provide the board feeding mechanism with a capability for measuring board width while each board is being passed through the mechanism. The information regarding actual board width may then be used to alter cuts made on other truss members to ensure that truss design data or specifications can be met despite variations in board width. As such, exemplary embodiments may enable increased precision with respect to truss member cutting and improved efficiency in truss assembly. Although embodiments of the present invention may benefit either a manual or automatic truss assembly processes, quality automatic assembly may be enhanced by employing embodiments of the present invention. Accordingly, for example, both the efficiency and quality of truss manufacturing may be improved.

According to one exemplary embodiment, an apparatus for providing dynamic measurement of an elongated work piece is provided. The apparatus may include a fence, a measurement device and at least one motion controller configured to engage at least one face of the work piece and move the work piece inline relative to the apparatus. The fence may be configured to engage a face of the work piece and define a first reference plane along which inline motion of the work piece progresses relative to the apparatus. The measurement device may be configured to engage an opposite face to the face of the work piece engaged by the fence to define a second reference plane, the measurement device being further configured to provide a digital measurement of a distance between the first reference plane and the second reference plane to an electronic device.

According to another exemplary embodiment, a system for providing automated truss assembly is provided. The system may include a truss assembly station configured to enable assembly of a truss from precision cut and pre-plated truss members, a pre-plating station for plating truss members using an automated pre-plating device, and a cutting station comprising a linear saw configured to cut work pieces into truss members. The cutting station may include a fence, a measurement device and at least one motion controller configured to engage at least one face of a work piece and move the work piece inline relative to the linear saw. The fence may be configured to engage a face of the work piece and define a first reference plane along which inline motion of the work piece progresses relative to the linear saw. The measurement device may be configured to engage an opposite face to the face of the work piece engaged by the fence to define a second reference plane, the measurement device being further configured to provide a digital measurement of a distance between the first reference plane and the second reference plane.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view illustrating a system that may benefit from exemplary embodiments of the present invention;

FIG. 2 is a perspective view illustrating an intake side of a motion controller having a dynamic measuring assembly according to an exemplary embodiment of the present invention;

FIG. 3 illustrates a top view of a dynamic measuring assembly according to an exemplary embodiment of the present invention; and

FIG. 4 is a perspective view illustrating an inbound motion controller and an outbound motion controller having dynamic measuring assemblies according to an exemplary embodiment of the present invention.

### DETAILED DESCRIPTION OF THE INVENTION

Embodiments of the present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like reference numerals refer to like elements throughout. Furthermore, as used herein “or” may be interpreted as a logical operator that results in true whenever one or more of its operands are true.

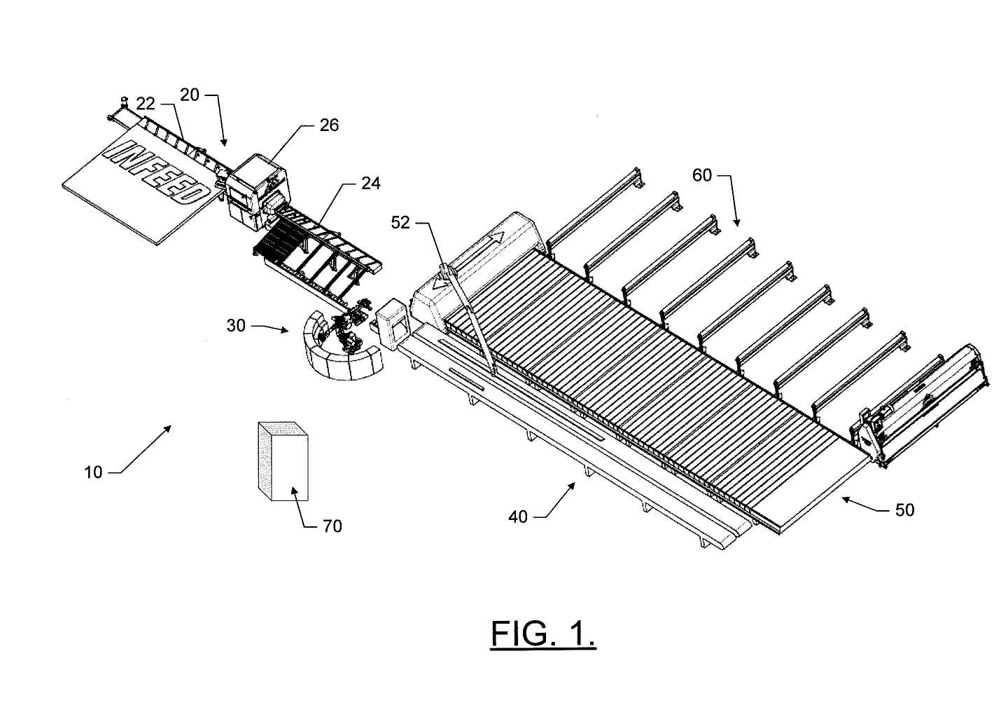

FIG. 1 is a basic block diagram illustrating a system 10 for automatic truss assembly that may benefit from exemplary embodiments of the present invention. However, it should be noted that embodiments of the present invention may also be used in applications other than automatic truss assembly. Furthermore, embodiments of the present invention may also be employed in connection with other assemblies comprised of precision cut members in which detailed knowledge of the dimensions of component members would be advantageous. Thus, although “members” and/or “work pieces” as described herein typically refer to lumber components, other components may also be processed in connection with embodiments of the present invention.

Referring now to FIG. 1, the system 10 may include various stations in which each station performs a particular function with respect to the overall function of the system 10. In particular, each station may represent a functional module which can be implemented in accordance with embodiments of the present invention. As such, embodiments of the present invention need not include, and in many cases may not include, every station. Indeed, embodiments of the present invention may enable the utilization of one or more, or even all of the stations for improving corresponding aspects of a truss manufacturing process, while not necessarily requiring a full implementation of the system shown. Stations not implemented in any particular embodiment may be replaced with conventional mechanisms for performance of corresponding functions or, for example, corresponding functions may be manually accomplished.

As shown in FIG. 1, the system 10 may include a cutting station 20, a pre-plating station 30, a pre-plated member transport station 40, a truss assembly station 50 and a truss transport station 60. Each of the stations will be described below in relation to the functions performed at the corresponding stations and exemplary structures for performing each respective function according to an exemplary embodiment.

The cutting station 20 may provide for the cutting of standard sized stock lumber pieces into truss members having lengths and angled ends appropriate for the planned location of the respective pieces in the finally assembled truss. In an exemplary embodiment, the cutting station 20 (and one or more of the other stations) may be controlled by a central computer (e.g., a control station 70) in order to make precision cuts of the lumber to create truss members or work pieces for use in assembling a truss. The cutting station 20 will be described in greater detail below.

After being cut at the cutting station 20, a work piece may be linearly extracted and passed along to the pre-plating station 30. The pre-plating station 30 may include, for example, an articulated robot arm configured to enable plating of selected ones of the work pieces passing through the pre-plating station 30 in selected locations. Determinations with regard to which work pieces to pre-plate and at which locations to secure such plates may be made based on truss design data (e.g., by the control station 70). Work pieces that have passed through the pre-plating station 30 may then be communicated to the pre-plated member transport station 40 where they may be translated, in some cases still in linear fashion, to the truss assembly station 50. At the truss assembly station 50, a truss assembler 52 (e.g., an assembly robot) may be configured to select and place each cut member (some of which are pre-plated) onto a jigging table for completion of truss assembly. The truss assembler 52 may perform precision placement of the truss members in a predefined order to take advantage of the pre-plating done at the pre-plating station 30. Once assembled, trusses may be transferred to the truss transport station 60, which may transport the assembled truss to a location for storage, stacking, and/or shipment.

The control station 70 may include at least a processor, memory, and a user interface for enabling the user to interface with the control station 70 to direct operations or pre-program operations of one or more of the stations. As an alternative, rather than using a central control mechanism such as the control station 70, embodiments of the present invention may be operated by entering job related information into a central database or local database of a respective machine controller of a device of each of the various stations described herein. As such, at each respective machine controller, job related information may be accessed and the corresponding device may operate according to specifications provided in association with the selected job. Each job may correspond to truss design data defining, for example, the length and types of cuts to be applied to each truss member or work piece, the positions and orientations of the plates for each joint, ordering of the truss members for placement in a jig and positions of such members in the jig, etc. In some embodiments, both the control station 70 and local machine controllers may be employed. In such situations, the control station 70 may coordinate at least some of the operations of the local machine controllers. As such, for example, the control station 70 may act as an operations supervisor making decisions about when to suspend certain functions (e.g., in order to prevent queue overloads, etc.) whereas the individual machine controllers may direct the minutia of operation for that specific machine. This may, in some cases, provide small enough response times at each machine to maximize efficiency and prevent collisions and the like.

In an exemplary embodiment, the control station 70 may store an application comprising computer readable program code portions (e.g., in the memory) for execution by the processor in which the execution of the application enables the provision of instructions to one or more respective stations for performance of a respective function as described in greater detail below. As such, the control station 70 may be in communication with one or more of the various stations (e.g., the cutting station 20, the pre-plating station 30, the pre-plated member transport station 40, the truss assembly station 50 and the truss transport station 60) or with certain components or devices of the respective stations. In connection with an exemplary embodiment, the control station 70 may store (e.g., in the memory) engineering drawings that may describe, for example, specifications for truss assembly (e.g., truss design data). In some cases, various different truss designs may be stored in association with different jobs via a job identifier, or each different truss design may be associated with its own unique job or truss identifier. Thus, for example, the control station 70 may be configured to provide information regarding a particular job or job identifier to one or more stations and a particular device or component of a respective station to which information is provided (e.g., the cutting station 20, the pre-plating station 30, the pre-plated member transport station 40, the truss assembly station 50 and the truss transport station 60) may utilize information regarding the identified job or truss in order to adjust set up parameters, operating parameters or positioning criteria based on the information. Thus, a particular work piece or member may receive treatment at each station in accordance with a single overall plan, job description or engineering drawing to ensure appropriate operations including cutting, transport, pre-plating, placement, assembly, etc., are performed with respect to each different work piece that may ultimately be used as a truss member for assembly of a truss, or for an entire job or work order comprising multiple trusses.

In an exemplary embodiment, the precision assembly of trusses by the truss assembler 52 may be controlled by the control station 70 and may be done based on truss design data accessed by the control station 70. Accordingly, in order to provide better capabilities for precision assembly by the truss assembler 52, it may be desirable to have an accurate knowledge of the width of the truss members used to assemble the truss. In particular, it may be useful to know the actual interior perimeter of the truss as defined by the truss chords, so that truss webs can be precision cut to enable automatic placement without gaps and/or excess at the joints between webs and chords. However, since some webs form joints with other webs, knowing truss web width may also be advantageous.

Accordingly, embodiments of the present invention may provide a mechanism by which the actual interior perimeter of the truss may be accurately known or predicted by enabling dynamic measurement of each truss member as the respective member is being passed through the system described above. More generally, embodiments of the present invention may enable dynamic measurement of truss members so that an accurate width of each member may be known and accounted for with respect to cutting members to fit a particular truss design. In this regard, a dynamic measuring assembly 100 is provided to illustrate one exemplary mechanism for enabling such a measurement. The dynamic measuring assembly 100 shown and described herein may be employed at any of various different points in the system 10. However, an exemplary embodiment will be described below in connection with employment of the dynamic measuring assembly 100 at a saw of the cutting station 20. Employment at the cutting station 20 (and in some cases, employment at an intake side of the cutting station 20) may be desirable since the work pieces being passed through the cutting station 20 may need to be cut on the basis of the measurements taken by the dynamic measuring assembly 100.

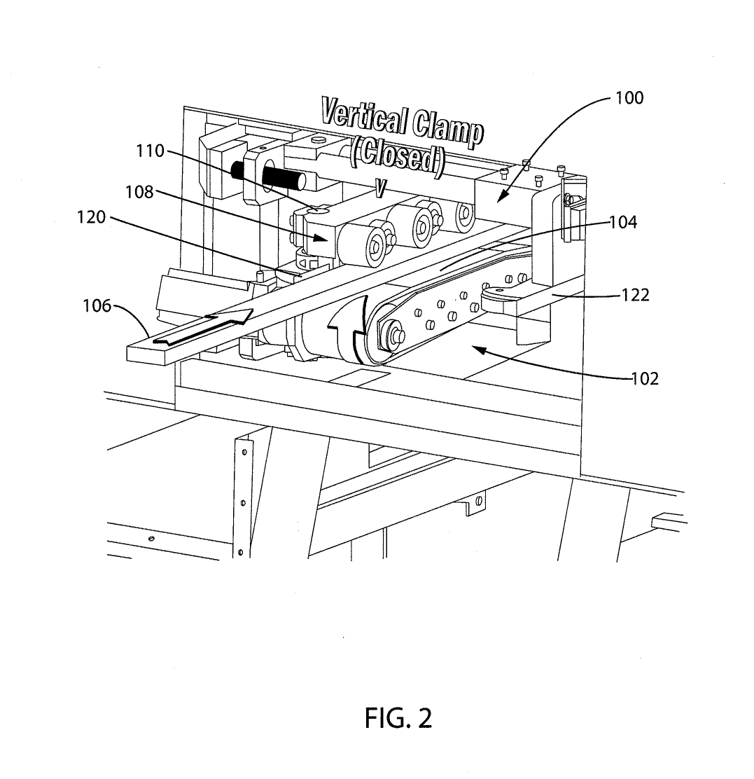

Notably, in cases where chord width is of primary concern, chords could be cut first and then the dynamic measuring assembly 100 could be embodied at the pre-plating station 30 or even the pre-plated member transport station 40, each of which may include motion control equipment useable in connection with embodiments of the present invention. As such, each chord member's width could be known and communicated to the control station 70 to enable cutting of the webs to be done in consideration of chord width for chords that a particular truss web may abut in a joint. However, for exemplary purposes, an embodiment will be described below in relation to FIGS. 2-4 where the dynamic measuring assembly 100 is embodied at the cutting station.

Referring now to FIGS. 1-4, the cutting station 20 may include an infeed assembly 22 and an outfeed assembly 24, each of which may be operatively coupled with a cutting device such as a saw. In an exemplary embodiment, the saw may be, for example, a linear saw 26 such as the Alpine Linear Saw (ALS) produced by Alpine Engineered Products. Thus, the linear saw 26 may be configured to receive stock lumber such as a board or piece of lumber transported linearly to the linear saw 26 by the infeed assembly 22 and transported linearly away from the linear saw 26 by the outfeed assembly 24. After cutting by the linear saw 26, a work piece is transported away from the cutting station 20. The work pieces referred to herein may include exemplary truss members or truss components.

In an exemplary embodiment, the infeed assembly 22 may include a conveyor such as rollers, a conveyor belt or other form of conveyance for providing a distal end of an elongated work piece, such as an end portion of a piece of lumber, into the linear saw 26. Similarly, the outfeed assembly 24 may also include a conveyor such as rollers, a conveyor belt or other form of conveyance for receiving a distal end of the work piece such from the linear saw 26 to transport the work piece from the linear saw 26 in a linear fashion. The rollers may all be powered or non-powered rollers. Alternatively, only certain ones of the rollers may be powered. Furthermore, in some embodiments, the conveyor may include a combination of belts and rollers. According to an exemplary embodiment, the infeed assembly 22, the outfeed assembly 24 and the linear saw 26 may all operate on a single board in sequence to enable the board to pass through the cutting station 20 in a linear or inline fashion.

The linear saw 26 may include an intake motion controller and an outbound motion controller that may take control of a work piece provided from the infeed assembly 22 and provide control to the outfeed assembly 24, respectively, for a work piece cut in the linear saw 26. In this regard, one of the intake motion controller and the outbound motion controller may operate as a master at any given time while the other operates as a slave. Each of the inbound motion controller and/or the outbound motion controller may be equipped to engage and transport a work piece through the linear saw (e.g., via a belt and/or roller mechanism). In an exemplary embodiment, both inbound motion controller and the outbound motion controller may include a clamping top and bottom roller or belt assembly between which the workpiece is passed and driven through frictional engagement. Dependent upon the work piece being cut, or the stage of the cutting of the work piece, the intake motion controller and the outbound motion controller may alternate master/slave operations to ensure proper cutting of the work piece as the work piece is passed linearly though the linear saw 26. The conveyor of either or both of the infeed assembly 22 and the outfeed assembly 24 may be powered or may be fed manually until the intake motion controller receives an inbound work piece or until the outbound motion controller releases an outbound workpiece.

FIG. 2 shows an example of an inbound motion controller 102 comprising a belt assembly 104 driven by powered rollers contacting one face of a member 106 (e.g., a bottom face having the widest dimension) to support the member 106. The inbound motion controller 102 may also include a roller assembly 108 positioned opposite of the belt assembly 104 with respect to the member 106 as the member 106 passes through the inbound motion controller 102. In an exemplary embodiment, the roller assembly 108 may be mounted on vertical supports 110 that may extent substantially perpendicular to the direction of travel of the member 106 as it passes through the inbound motion controller 102. Accordingly, the roller assembly 108 may be movable in a direction substantially perpendicular to the direction of travel of the member 106 in order to permit engagement with members of various different thicknesses. In some embodiments, the roller assembly 108 and the belt assembly 104 may form a vertical clamp to engage the member 106 for controlling motion of the member 106 through the inbound motion controller 102 via frictional engagement with the member 106. The dynamic measuring assembly 100 may include components to form a horizontal clamp as described in greater detail below. However, it should be noted that the terms horizontal and vertical could be interchanged if members are passed through the cutting station 20 resting on a face having their narrowest dimension instead of being passed through the cutting station 20 resting on a face having the broadest dimension as shown in FIGS. 2-4.

The dynamic measuring assembly 100 may include a back fence 120 positioned to provide a first reference plane against which the member 106 may be held in contact while passing through the dynamic measuring assembly 100. The back fence 120 could be embodied as one or more rollers aligned to rotate about a vertical axis that extends perpendicular to the direction of motion of the member 106 through the dynamic measuring assembly 100 and/or a rigid but smooth surface extending parallel to the direction of motion of the member 106 and perpendicular to the plane of the belt assembly 104. If rollers are used, the rollers may be installed such that a tangent to the outer edge of each roller may be aligned to the first reference plane. The back plane 120 may provide a reference point from which the width of the member 106 may be measured using a clamp 122. The clamp 122 may be positioned to face opposite of the back fence 120 with respect to the member 106. The clamp 122 may include a portion or surface (which may be continuous or comprised of one or more extensions from a main body of the clamp 122 for providing a mounting surface for rollers aligned with each other in a plane) forming a second reference plane that may extend parallel to the first reference plane.

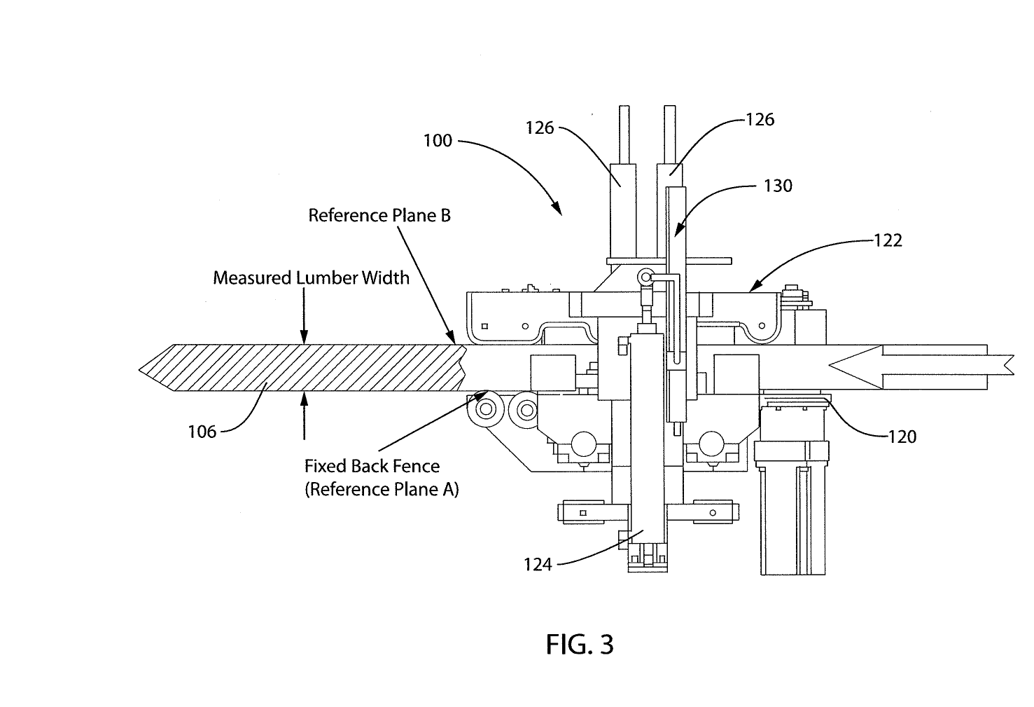

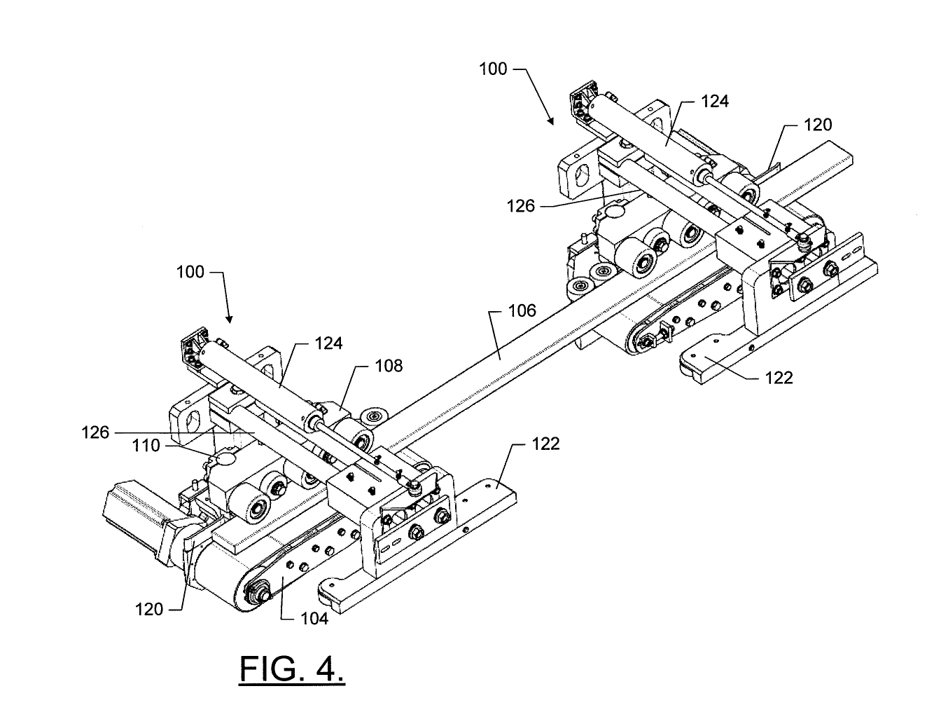

In an exemplary embodiment, the clamp 122 may have an open position (as shown in FIGS. 2 and 4) in which the clamp 122 is not placed in engagement with the member 106, and a closed position (as shown in FIG. 3) in which the clamp 122 is placed in engagement with the member 106. When in the closed position, the clamp 122 may be held in engagement with the member 106 using a contraction mechanism configured to draw the clamp 122 toward the back fence 120. In an exemplary embodiment, the contraction mechanism may be embodied as an air cylinder 124 biased to contract. Other alternatives for the contraction mechanism may include, but are not limited to, a hydraulically operated closing device or a servo motion controlled system.

As shown in FIG. 3, for example, the clamp 122 may ride on one or more support rails 126 that may extend over (or under) the inbound motion controller 102 in a direction substantially perpendicular to the direction of motion of the member 106 through the inbound motion controller 102. The clamp 122 may therefore be pulled along the support rails 126 toward the back fence 120 by the closing bias force exerted by the air cylinder 124. When the clamp 122 is pulled into engagement with one side of the member 106, the engagement of an opposite face of the member 106 with the back fence 120 may create a measurable distance between the first and second reference planes. The distance between the first and second reference frames may be indicative of the width of the member 106 at the corresponding location at which the measurement is made.

In an exemplary embodiment, the dynamic measuring assembly 100 may include a measuring device such as an electronic digital scale 130. The measuring device may be configured to measure the distance between the first and second reference planes. In some cases, the measuring device may be configured to only take readings at specified times and/or locations when the clamp 122 is in the closed position. In an exemplary embodiment, the digital scale 130 may measure member width at predetermined times and/or locations for each or various members as they pass through the linear saw 26. In this regard, for example, the digital scale 130 may be configured to take measurements at fixed intervals (e.g., every foot, every six inches, etc.) or at other fixed locations (e.g., lengthwise middle of the member, two feet from an end, etc.) or times. Each of the width measurements taken by the digital scale 130 may be reported to a database (e.g., associated with the control station 70) and logged in association with the corresponding member. As such, for example, each member may have corresponding width data indicative of the width of the member at various locations along the member's length. Thus, if by the truss design data a joint will be at a particular position along the length of a truss chord, any web cut to engage the truss chord may be cut in consideration of the actual width of the truss chord at the location along the truss chord corresponding to where the joint will be formed. In an exemplary embodiment, the width data from reports given by the digital scale may therefore be accessed by the control station 70 to control the cutting of the linear saw 26 for other truss members to provide precision cutting of truss members in accordance with the truss design data and actual lumber dimensions.

As discussed above, it may be useful to cut and measure width data for chords prior to cutting any web that may engage a particular chord. In some embodiments, it may be desirable to cut all chords prior to cutting any webs so that an entire actual interior perimeter of the truss may be determined. The actual interior perimeter data may be used to update truss design data for use in cutting webs. Enabling accurate cutting of the chords and webs as described herein may provide better placement of the plates in an automatic pre-plating situation, but may also provide for better fitting of truss members in each joint and therefore better quality trusses.

In an exemplary embodiment, a member being cut may be stopped at various locations while the linear saw 26 is performing precision cuts. The stopping may be accomplished using either the inbound or outbound motion controller (e.g., whichever is the master at that time) to stop movement of a member located therein. The digital scale 130 may be configured to take a measurement each time the member stops. However, it may also be possible to take such measurements on moving pieces, or stop pieces at advantageous locations in order to make measurements.

In this regard, in some embodiments, desirable locations for measuring width may include the locations of the joints in the truss. As such, if it is desirable to limit the number of points where measurements are taken in order to maintain data collection speeds or not to overrun data storage capacities, width measurements at the joints would typically be the information of most value. The position of the joints is known at the time of cutting and the controllers of the system/machine may be instructed with regard to where to take the width measurements at those corresponding locations.

In some embodiments, the vertical clamp created by the belt assembly 104 and the roller assembly 108 could employ a digital scale in order to measure member thickness in a similar fashion to that described above. This may be of particular value in parts of the world where the thickness of lumber varies on purpose as opposed to “uncontrolled” variances. For example, the US and Canada are currently the only countries in the world that have rigorously limited the standard thickness of their structural lumber that is used in truss manufacturing to 1.5″ (2″ nominal). Accordingly, in other areas of the world, embodiments of the present invention may be useful in accurately determining member thickness as well. It should also be noted that although FIG. 4 shows two motion controllers (e.g., input and output motion controllers) which each have dynamic measuring assemblies, it is not necessary for each motion controller to include a dynamic measuring assembly. As such, either one or both of the motion controllers may include a dynamic measuring assembly in various different embodiments of the present invention.

Many modifications and other embodiments of the inventions set forth herein will come to mind to one skilled in the art to which these embodiments pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

That which is claimed:

1. An apparatus configured to provide dynamic measurement of an elongated work piece, the apparatus comprising:
at least one motion controller configured to engage at least one face of the work piece and move the work piece inline relative to the apparatus;
a fence configured to engage a face of the work piece and define a first reference plane along which inline motion of the work piece progresses relative to the apparatus; and
a measurement device configured to engage an opposite face to the face of the work piece engaged by the fence to define a second reference plane, the measurement device being further configured to provide a digital measurement of a distance between the first reference plane and the second reference plane to an electronic device.

2. The apparatus of claim 1, wherein the at least one motion controller includes an inbound motion controller that engages the work piece as the work piece enters the apparatus and an outbound motion controller that engages the work piece as the work piece exits the apparatus.

3. The apparatus of claim 1, wherein the fence includes a plurality of rollers configured such that a tangent to an outer edge of each of the rollers is aligned to the first reference plane.

4. The apparatus of claim 1, wherein the measurement device comprises a clamp configured to draw the clamp toward the fence.

5. The apparatus of claim 4, wherein the measurement device further comprises an air cylinder biased to contract the clamp toward the fence.

6. The apparatus of claim 1, wherein the measurement device is configured to perform a measurement of a width of the work piece at a plurality of points along the work piece.

7. The apparatus of claim 6, wherein the measurement device is configured to perform measurements at fixed intervals along the work piece.

8. The apparatus of claim 6, wherein the measurement device is configured to perform measurements at predetermined locations along the work piece.

9. The apparatus of claim 6, wherein the measurement device is configured to perform measurements at predetermined time intervals.

10. The apparatus of claim 1, wherein the apparatus comprises a linear saw.

11. The apparatus of claim 1, wherein the measurement device outputs each measurement to a database.

12. The apparatus of claim 1, wherein the apparatus comprises a linear saw configured to cut truss members, wherein the apparatus is configured to cut chord members prior to cutting web members, and wherein the measurement device is configured to output each measurement to a database to enable the apparatus to cut the web members based on an internal area of a truss as defined by width measurements made on the chord members.

13. The apparatus of claim 12, wherein the linear saw is configured to cut the truss members based on truss design data as modified by actual work piece dimensions measured by the measurement device.

14. The apparatus of claim 1, wherein the measurement device is configured to perform the digital measurement while the work piece is moving.

15. The apparatus of claim 1, wherein the measurement device is configured to perform the digital measurement while the at least one motion controller holds the work piece stationary.

16. An automated truss assembly system comprising:
a truss assembly station configured to enable assembly of a truss from precision cut and pre-plated truss members;
a pre-plating station for plating truss members using an automated pre-plating device; and
a cutting station comprising a linear saw configured to cut work pieces into truss members, the cutting station further comprising:
at least one motion controller configured to engage at least one face of a work piece and move the work piece inline relative to the linear saw;
a fence configured to engage a face of the work piece and define a first reference plane along which inline motion of the work piece progresses relative to the linear saw; and
a measurement device configured to engage an opposite face to the face of the work piece engaged by the fence to define a second reference plane, the measurement device being further configured to provide a digital measurement of a distance between the first reference plane and the second reference plane.

17. The automated truss assembly system of claim 16, wherein the measurement device is configured to perform a measurement of a width of the work piece at a plurality of points along the work piece at fixed intervals along the work piece, at predetermined locations along the work piece, or at predetermined time intervals.

18. The automated truss assembly system of claim 16, wherein the measurement device outputs each measurement to a database.

19. The automated truss assembly system of claim 16, wherein the linear saw is configured to cut chord members prior to cutting web members, and wherein the measurement device is configured to output each measurement to a database to enable the apparatus to cut the web members based on an internal area of a truss as defined by width measurements made on the chord members.

20. The automated truss assembly system of claim 16, wherein the measurement device is configured to perform the digital measurement while the work piece is moving.
